(19) United States
(12) Patent Application Publication
(10) Pub. No.: US 2010/0074367 A1
(43) Pub. Date: Mar. 25, 2010

(54) ADAPTIVE COMBINER ERROR CALIBRATION ALGORITHMS IN ALL-DIGITAL OUTPHASING TRANSMITTER

(75) Inventors: Kwan-Woo Kim, Sunnyvale, CA (US); Kyutae Lim, Alpharetta, GA (US); Chang-Ho Lee, Marietta, GA (US); Haksun Kim, Seo-gu (KR); Joy Laskar, Marietta, GA (US)

Correspondence Address: SUTHERLAND ASBILL & BRENNAN LLP, 999 PEACHTREE STREET, N.E., ATLANTA, GA, 30309, US

(73) Assignee: SAMSUNG ELECTRO-MECHANICS COMPANY, LTD., Gyunggi-Do (KR)

(21) Appl. No.: 12/561,890

(22) Filed: Sep. 17, 2009

Related U.S. Application Data
(60) Provisional application No. 61/098,501, filed on Sep. 19, 2008.

(51) Int. Cl. H04L 25/03; H04L 27/12

(52) U.S. Cl. 375/296; 375/302

(57) ABSTRACT

Systems and methods may include a signal component separator that receives a non-constant envelope input signal and at least one phase offset value, and generates first digital phase data and second digital phase data; at least one digital phase modulator that receives the first phase data and the second phase data and operates with a frequency synthesizer to generate a first component signal having a first constant envelope and a second component signal having a second constant envelope; at least one power amplifier that amplifies the first component signal and the second component signal; a non-isolated power combiner that combines the first amplified component signal and the second amplified component signal to generate an output signal having a non-constant envelope; and a mismatch compensator that monitors the output signal to determine the at least one phase offset value, where the at least one phase offset value is utilized by the signal component separator for phase adjustment.

### RELATED APPLICATION

The present application claims priority to U.S. Provisional Application No. 61/098,501, filed on Sep. 19, 2008, and entitled “ADAPTIVE COMBINER ERROR CALIBRATION ALGORITHMS IN ALL-DIGITAL OUTPHASING TRANSMITTER.” The foregoing application is hereby incorporated by reference in its entirety.

### FIELD OF THE INVENTION

Embodiments of the present invention relate generally to systems and methods for adaptive error calibration algorithms in an all-digital outphasing transmitters.

### BACKGROUND OF THE INVENTION

In recent communication systems, the necessity for efficient frequency spectrum usage leads to the use of some modulation methods such as QAM (quadrature amplitude modulation) and OFDM (orthogonal frequency division multiplexing), which modulate data on not only the phase but also the amplitude of a carrier signal and consequently generates a signal having non-constant envelope. In general, to transmit a signal having non-constant envelope, a linear power amplifier that is inefficient in power consumption is used rather than a nonlinear power amplifier that is efficient in power consumption. As a possible solution for this problem, an outphasing (also called (LINC) linear amplification using nonlinear components) transmitter shown in FIG. 1 was first introduced in D. C. Cox, “Linear amplification with nonlinear components,” IEEE Trans. on Communications, vol. COM-22, pp. 1942-1945, December 1974. In general, as shown by FIG. 1, an outphasing method is a method in which 1) an original analog signal S(t) having non-constant envelope is split into two analog signals S₁(t), S₂(t) having constant envelope, 2) each split signal S₁(t), S₂(t) is amplified by a respective power-efficient nonlinear power amplifier 161, 162, and 3) the two amplified signals are combined by a power combiner 170 and transmitted as Sₒᵤₜ(t) by antenna 180. FIG. 2 is a diagram illustrating signal vectors of two signals (S₁(t), S₂(t) having constant envelope and the original signal (S(t)) having non-constant envelope. FIG. 2 shows that an original signal S(t) having non-constant envelope can be always split into two signals S₁(t), S₂(t) having constant envelope so that when the two split signals having constant envelope are combined, they can always represent the original signal having non-constant envelope. Instead of using a linear power amplifier, an outphasing transmitter uses two nonlinear power amplifiers for transmitting a signal having non-constant envelope so that it is an efficient method for both spectrum usage and power consumption.

Conventionally, analog methods were used for separating an original signal having non-constant envelope into two signals having constant envelope in an outphasing transmitter. Analog methods may include utilizing an analog quadrature modulator shown in US Patent Publication No. 2004/0185805 (LINC power transmitter), U.S. Pat. No. 6,054,894 (Digital control of a LINC linear power amplifier), U.S. Pat. No. 6,633,200 (Management of internal signal level and control of the net gain for a LINC amplifier), X. Zhang, etc, “Gain/phase imbalance-minimization techniques for LINC transmitters,” IEEE Trans. on MTT, vol. 49, no. 12, pp. 2507-2516, December 2001; or an analog phase modulator shown in S. Hamedi-Hagh and C. A. T. Salama, “CMOS wireless phase-shifted transmitter,” IEEE Journal of Solid-State Circuits, vol. 39, no. 8, pp. 1241-1252, August 2004. These analog methods may be complicated to implement and difficult to compensate phase and amplitude errors between two signal paths.

### SUMMARY OF THE INVENTION

Embodiments of the invention may provide for an all-digital outphasing transmitter having a novel combiner error compensation mechanism. The digital outphasing transmitter may include one or more of: a signal component separator, a digital phase modulator, a frequency synthesizer, a power amplifier, a power combiner, an antenna, and a mismatch compensator. The digital outphasing transmitter may use a digital control input. Thus, a digital outphasing transmitter in accordance with an example embodiment of the invention may easily compensate phase for various power combiner errors due to its non-isolated effects.

According to an example embodiment of the invention, there is a digital outphasing transmitter. The transmitter may include a signal component separator that receives a non-constant envelope input signal and at least one phase offset value, and generates first digital phase data and second digital phase data; at least one digital phase modulator that receives the first phase data and the second phase data and operates with a frequency synthesizer to generate a first component signal having a first constant envelope and a second component signal having a second constant envelope; at least one power amplifier that amplifies the first component signal and the second component signal to generate an amplified first component signal and an amplified second component signal; a power combiner that combines the first amplified component signal and the second amplified component signal to generate an output signal having a non-constant envelope, where the power combiner is of a non-isolated type; and a mismatch compensator that monitors the output signal to determine the at least one phase offset value, where the at least one phase offset value is utilized by the signal component separator for phase adjustment.

According to another example embodiment of the invention, there is a method for a digital outphasing transmitter. The method may include generating, by a signal component separator, first digital phase data and second digital phase data based upon a non-constant envelope input signal and at least one phase offset value; receiving, by at least one digital phase modulator, the first phase data and the second phase data, where the at least one phase modulator operates with a frequency synthesizer to generate a first component signal having a first constant envelope and a second component signal having a second constant envelope; amplifying, by the at least one power amplifier, the first component signal and the second component signal to generate an amplified first component signal and an amplified second component signal; combining, by a power combiner, the first amplified component signal and the second amplified component signal to generate an output signal having a non-constant envelope, wherein the power combiner is of a non-isolated type; and monitoring, by a mismatch compensator, the output signal to determine the at least one phase offset value, where the at least one phase offset value is utilized by the signal component separator for phase adjustment.

### BRIEF DESCRIPTION OF THE DRAWINGS

The above and other features and advantages of the present invention will become more apparent to those of ordinary skill in the art by describing in detail example embodiments thereof with reference to the attached drawings in which:

FIG. 1 is a simplified block diagram illustrating a basic outphasing transmitter.

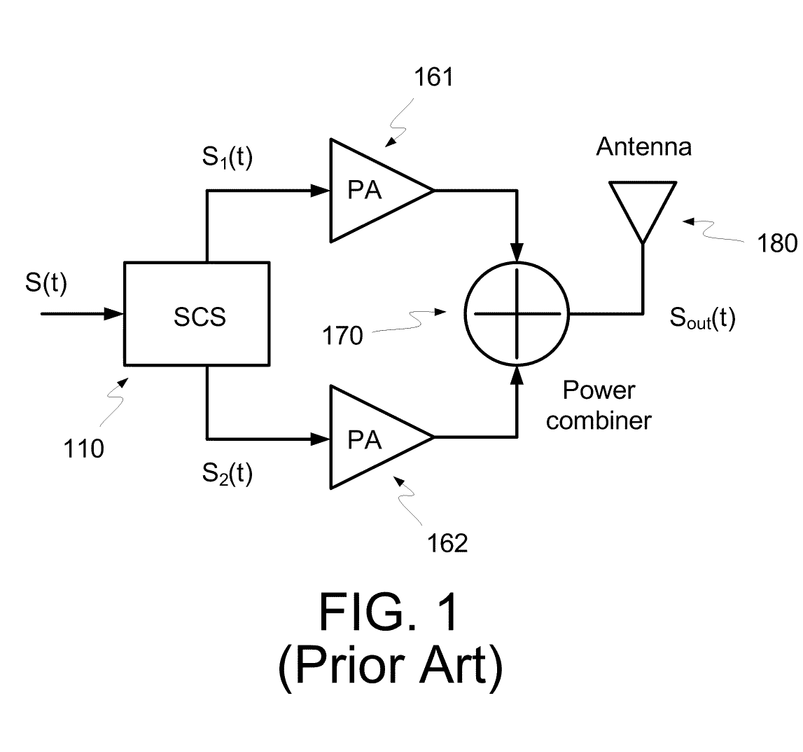

FIG. 2 is a diagram illustrating signal vectors of some signals in FIG. 1.

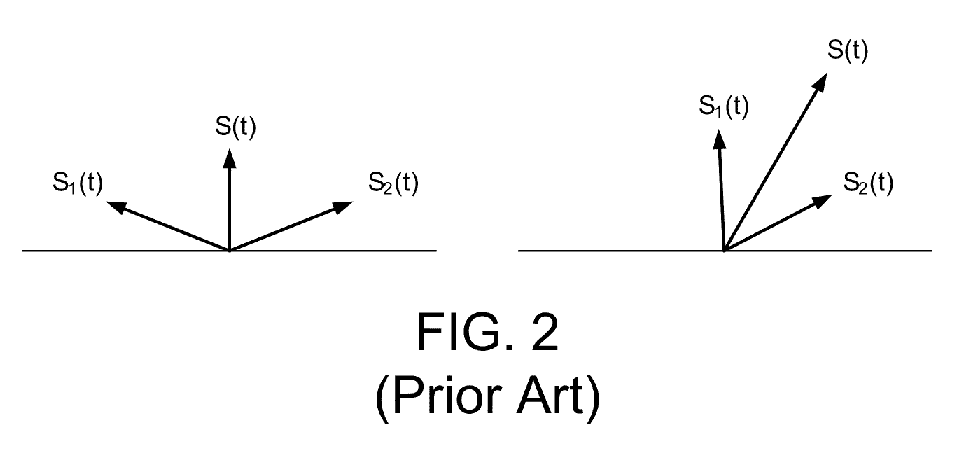

FIG. 3 is an example block diagram illustrating a digital outphasing transmitter having digital phase modulators, according to an example embodiment of the invention.

FIG. 4 is an example block diagram illustrating a simplified circuit model of power amplifiers and a power combiner in an outphasing transmitter, according to an example embodiment of the invention.

FIG. 5 is an example graph illustrating test vectors applied for digital mismatch calibration, according to an example embodiment of the invention.

FIG. 6 is an example graph illustrating output signal distortion due to phase error, according to an example embodiment of the invention.

FIG. 7 is an example graph illustrating output signal distortion die to amplitude error, according to an example embodiment of the invention.

FIG. 8 is an example graph illustrating an example combiner response to the conjugate phase test signals, according to an example embodiment of the invention.

FIG. 9 is an example graph illustrating calibrated vectors for error compensation, according to an example embodiment of the invention.

FIG. 10 is an example graph illustrating an example phase response after phase error compensation, according to an example embodiment of the invention.

FIG. 11 is an example graph illustrating an example amplitude response after amplitude error compensation, according to an example embodiment of the invention.

FIGS. 12A and 12B show example simulation results demonstrating the performance of example calibration with example OFDM communication signals, according to an example embodiment of the invention

### DETAILED DESCRIPTION OF THE INVENTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Embodiments of the invention may be directed towards systems and methods for a combiner error compensation algorithm for a digital outphasing transmitter. More specifically, embodiments of the invention may include an example compensation mechanism for a non-isolated power combiner in an outphasing transmitter. The compensation mechanism may be applied to an outphasing system implemented using digital phase modulators. In an example embodiment of the invention, the compensation mechanism may be utilized to support a non-isolated power combiner such as a Chireix combiner. In general, a non-isolated power combiner can provide high efficiency and good linearity. In contrast, an isolated power combiner such as a Wilkinson combiner can have significant energy degradation when the outphase angle is close to 180°. However, while the non-isolated power combiner provides high efficiency and good linearity, the equivalent impedance of input port of the non-isolated power combiner varies depending on the phase of the input. This time-varying impedance may distort the output signal significantly. Accordingly, to eliminate or minimize any potential distortion in the output signal, a non-isolated power combiner with adaptive error calibration may be utilized, as described herein in accordance with example embodiments of the invention.

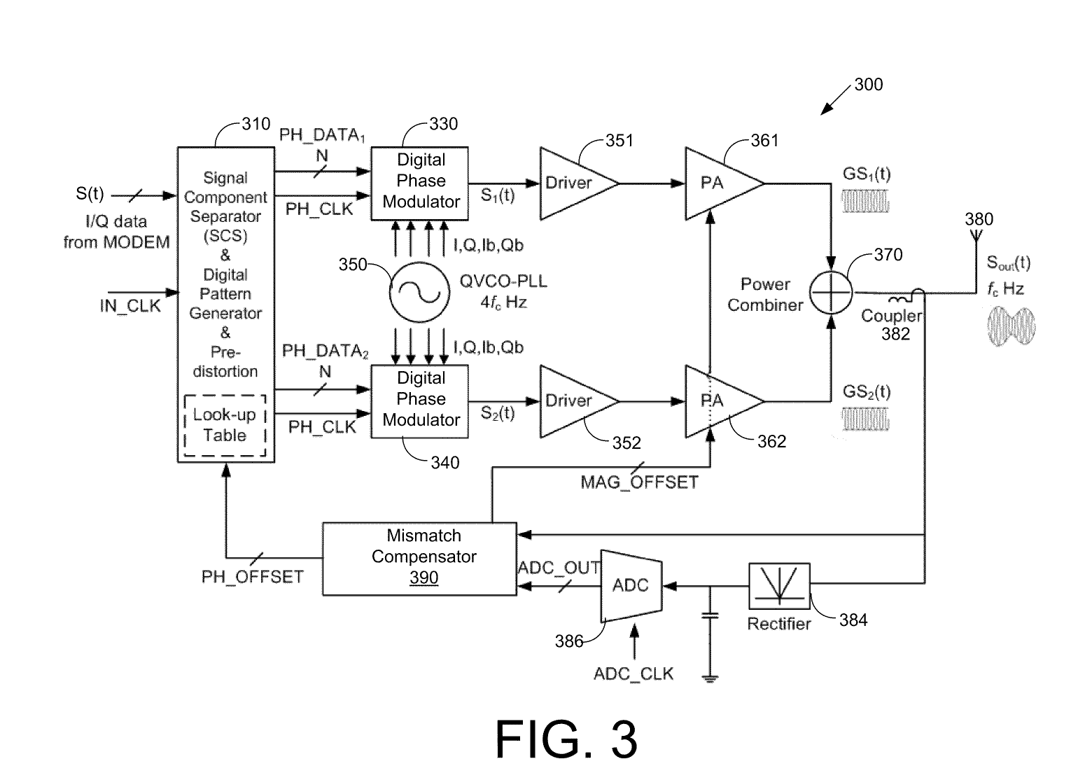

FIG. 3 illustrates a block diagram illustrating an example digital outphasing transmitter 300, according to an example embodiment of the invention. The outphasing transmitter 300 may include one or more of the following: a signal component separator (SCS) 310; digital phase modulators 330, 340; a frequency synthesizer 350; driver amplifiers 351, 352; power amplifiers 361, 362; a power combiner 370; an antenna 380; and a mismatch compensator 390, according to an example embodiment of the invention

The signal component separator (SCS) 310 may be operative to calculate and output two phase data PH_DATA₁, PH_DATA₂ using a phase offset PH_OFFSET received from the mismatch compensator 390 and an input signal S(t) (e.g., I/Q data) having non-constant envelope from a MODEM or other source. It will be appreciated that the input signal S(t) (e.g., I/Q data) may be received by the signal component separator (SCS) 310 in analog form from the MODEM or other source. The signal component separator 310 may use a digital pattern generator to covert the analog input signal S(t) into the digital phase data PH_DATA₁ and PH_DATA₂, which may each be comprised of N bits, according to an example embodiment of the invention. Also, as the phase offset PH_OFFSET is a digital value with a finite number, the offset values are saved digitally in the look-up table and used for the data conversion and predistortion in the digital pattern generator. In conjunction with generating the phase data PH_DATA₁, PH_DATA₂, the signal component separator 310 may also generate phase clock data PH_CLK, which may provide timing signal to transfer the digital phase data PH_DATAᵢ, PH_DATA₂ to digital phase modulator 330, 340.

The digital phase modulators 330, 340 may operate in the digital domain to receive phase data PH_DATA₁, PH_DATA₂ and phase clock data PH_CLK. The digital phase modulators 330, 340 may be operative to modulate analog I/Q clock signals or other sinusoidal signals from the frequency synthesizer 350 with respective phase data PH_DATAᵢ, PH_DATA₂/clock data PH_CLK from the signal component separator 310 to generate to generate two respective analog component signals S₁(t), S₂(t) that each have a constant envelope.

The frequency synthesizer 350 may be operative to generate I/Q clock signals having a frequency that is four times faster than the frequency of the transmitted output signal Sₒᵤₜ(t) from the antenna 380 of the outphasing transmitter 300. By way of example, when the carrier frequency of the transmitted signal Sₒᵤₜ(t) is 600 MHz, the frequency synthesizer 350 may generate I/Q clock signals having a frequency of 2.4 GHz. These 2.4 GHz I/Q clock signals may be generated by coupling two LC oscillators operating at 2.4 GHz or by dividing a 4.8 GHz clock signal from a 4.8 GHz LC oscillator. According to another example, when the carrier frequency of the transmitted signal Sₒᵤₜ(t) is 2.5 GHz, the frequency synthesizer 350 may generate I/Q clock signals having a frequency of 10 GHz.

These two component signals S₁(t), S₂(t) from the respective digital phase modulators 330, 340 may be amplified by respective driver amplifiers (PAs) 351, 352 and respective power amplifiers 361, 362. The two respective amplified analog outputs GSM), GS₂(t) of the power amplifiers 361, 362 may be combined by a power combiner 370 to generate an analog combined output signal Sₒᵤₜ(t). The power combiner 370 may be a non-isolated power combiner, according to an example embodiment of the invention. The combined output signal Sₒᵤₜ(t) may be transmitted from the antenna 380.

The mismatch compensator 390 may detect phase and/or amplitude mismatches or errors by analyzing the transmitted signal Sₒᵤₜ(t) or a representation of the transmitted signal Sₒᵤₜ(t). As an example, a coupler 382 may provide a representation (e.g., an attenuated signal) of the transmitted signal Sₒᵤₜ(t) to a rectifier 384. An output of the rectifier 384 may be provided to an analog-to-digital converter (ADC) 386. The output ADC OUT of the ADC 386 may be provided to the mismatch compensator 390 for analysis.

Based upon any detected phase and/or amplitude mismatches or errors, the mismatch compensator 390 may generate compensation data values (e.g., magnitude offset MAG_OFFSET and phase offset PH_OFFSET) in order to compensate for the detected phase and/or amplitude mismatches or errors. The mismatch compensation (590) may store the detected phase and amplitude offsets provided by the compensation data values (PH_OFFSET and MAG_OFFSET). According to an example embodiment, at least one magnitude offset MAG_OFFSET may be provided to the power amplifiers 361, 362 in order to digitally control the respective power gains. For instance, power amplifiers 361, 362 in an actual implementation may have slightly different gain characteristics. Accordingly, the mismatch compensator 390 may calibrate the two power amplifiers 361, 362 using the magnitude offset MAG_OFFSET to compensate for the slightly different gain characteristics that would otherwise contribute to amplitude and/or phase errors in the output signal Sₒᵤₜ(t), according to an example embodiment of the invention.

In another example, at least one phase offset PH_OFFSET may be provided to the signal component separator 310. The phase offset PH_OFFSET may indicate the phase offset value needed to minimize amplitude and/or phase errors, which may be caused at least in part by the power combiner 370. For example, there may be imperfect phase cancellation by the power combiner 370, or amplitude distortions resulting from varying equivalent load impedance at the output of the power combiner 370. The phase offset value provided by the phase offset PH_OFFSET may be determined by the mismatch compensator 390 in accordance with common phase predistortion, differential phase predistortion, or a combination thereof, as described herein. The signal component separator 310 may use the phase offset PH_OFFSET to provide the appropriate predistortion when generating the respective phase data PH_DATAᵢ, PH_DATA₂ such that the resulting two component signals S₁(t) and S₂(t) have the appropriate phases (e.g., due to same phase compensation under common phase predistortion or differential phase compensation under differential phase predistortion).

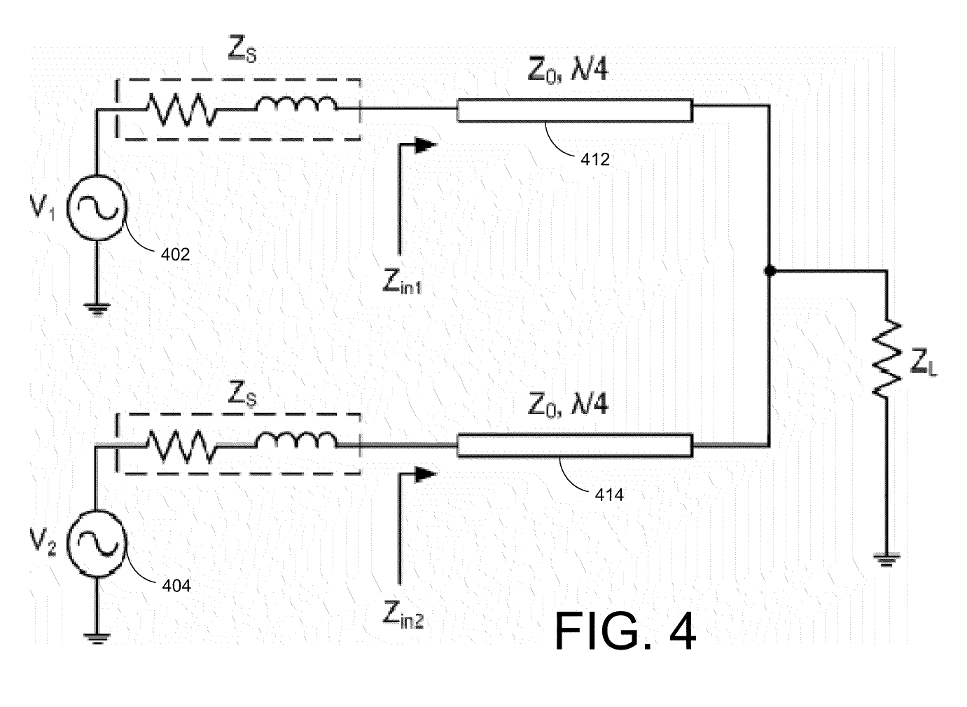

FIG. 4 is an example block diagram illustrating a simplified circuit model of power amplifiers and a power combiner in an outphasing transmitter, according to an example embodiment of the invention. In FIG. 4, the two power amplifiers may be represented by ideal voltage sources V₁ 402 and V₂ 404 each having a respective output impedance of Z_{S}. The power combiner may be comprised of two quarter-wave transformers 412, 414 and a common load resistor Z_{L}. As the architecture of the combiner may be of a non-isolated type, the input impedance Zᵢₙ looking into the each quarter-wave transformer, may be written by the function of input signals V₁ 402 and V₂ 404. By using the calculated input impedance Zᵢₙ, the reflection coefficient Γ, and a transmission coefficient T, may be provided as

$$Γ = \frac{{Z}_{in} - {Z}_{S}}{{Z}_{in} + {Z}_{S}} , T = 1 + Γ ,$$

respectively. However, in the calculation of the coefficients, the output impedance Z_{S} of the power amplifier may also be affected by the input impedance Zᵢₙ. The affected impedance of power amplifier cannot be modeled by numerical formulas, and thus, it is impossible to calculate the exact output voltage. Accordingly, experimental measurements using test signals may instead be utilized.

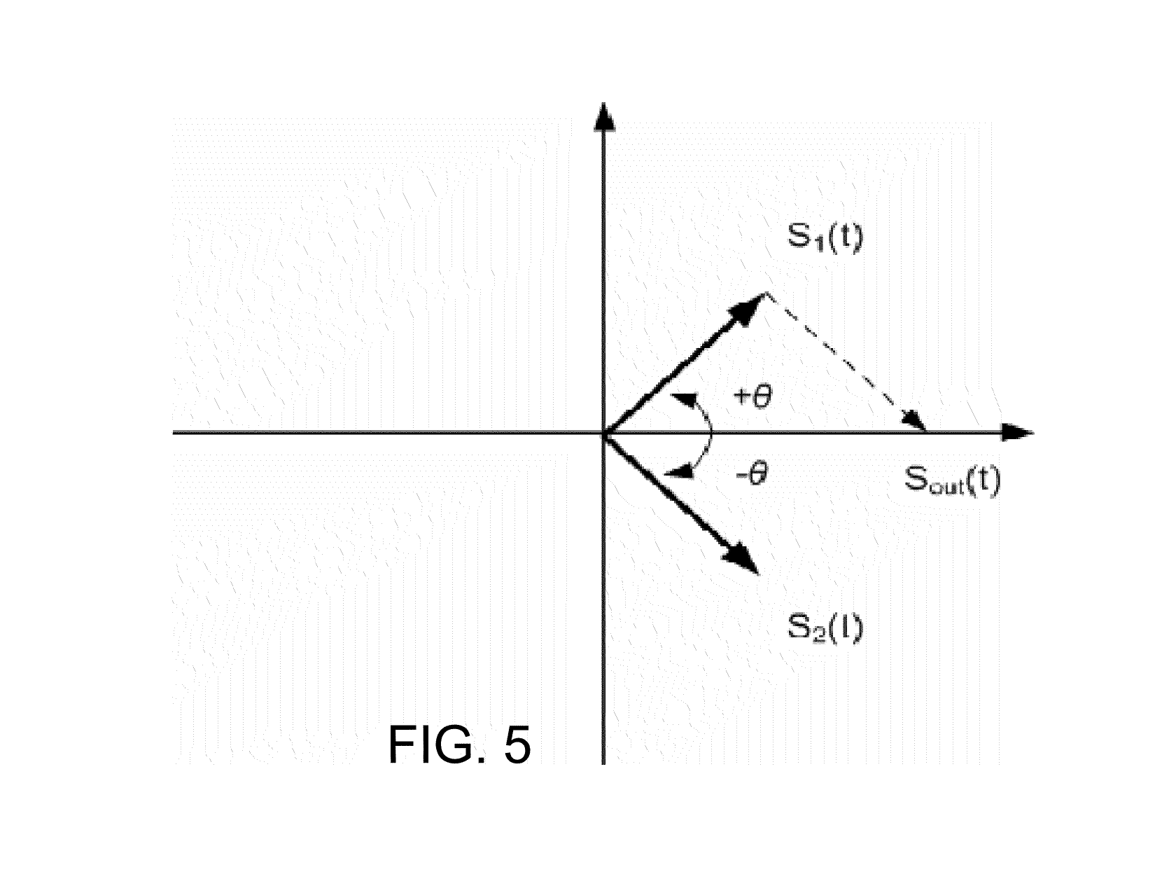

FIG. 5 is an example graph illustrating the example test vectors to be used for digital mismatch calibration, according to an example embodiment of the invention. The test vectors S₁(t), S₂(t) may be symmetrical on a horizontal axis. The signal output Sₒᵤₜ(t) generated by the test vectors S₁(t), S₂(t) should be on the horizontal axis regardless of input angle θ, because of the symmetry. However, a varying imaginary element in the output impedance of power amplifier may cause imperfect phase cancellation in the power combiner, thereby generating phase errors at the output of combiner. Thus, the imperfect phase cancellation may be a first element to be calibrated by predistortion, according to an example embodiment of the invention. In addition, magnitude variations in the equivalent load impedance result in amplitude distortion at the output of the outphasing transmitter. Thus, the amplitude distortion may be a second element to be calibrated by predistortion, according to an example embodiment of the invention.

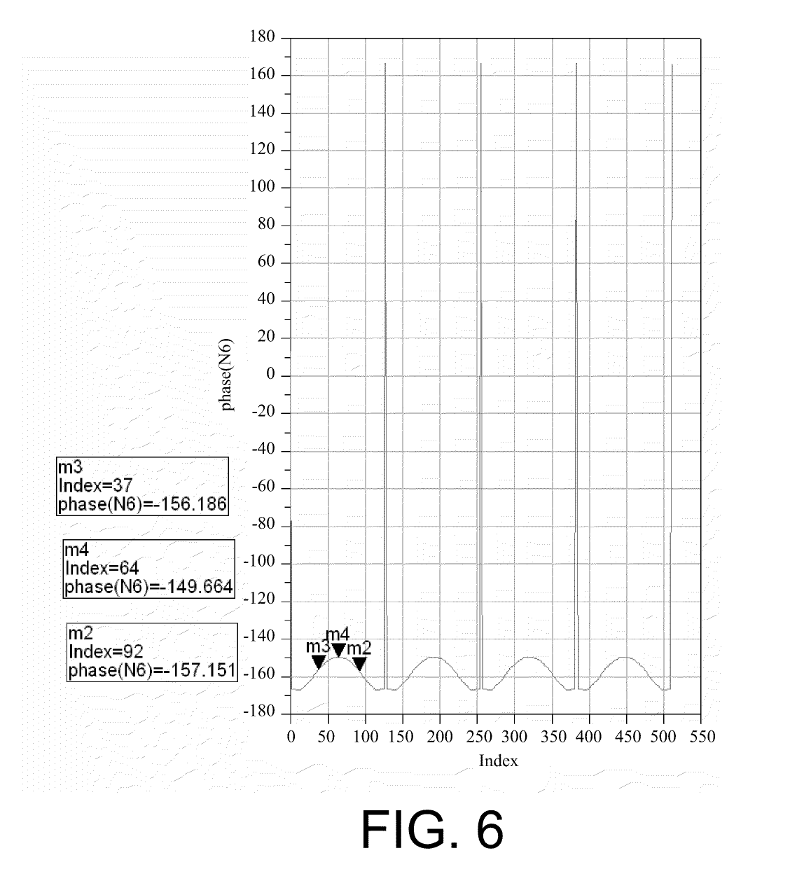

FIG. 6 is an example graph illustrating output signal distortion due to phase error generated by non-perfect cancellation, according to an example embodiment of the invention. As shown, the phase of the output signal changes based upon the input phase differences. In order to compensate for the phase error, the phases of two inputs may be provided with the same phase compensation values, which may be generally referred to as common phase predistortion.

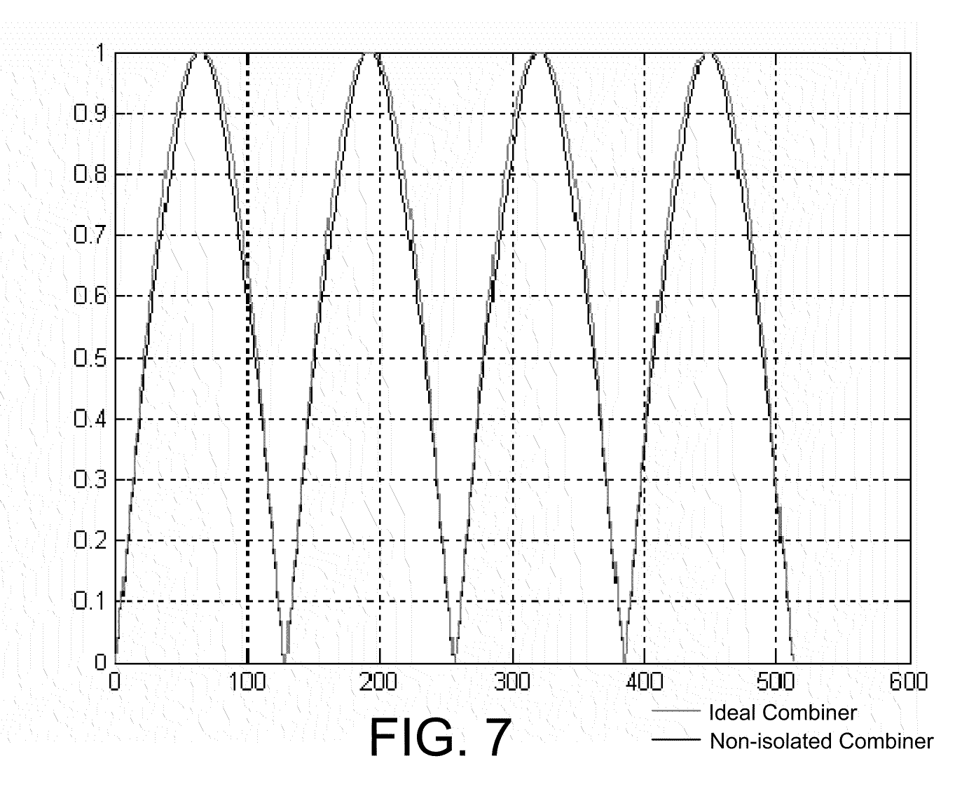

FIG. 7 is an example graph illustrating output signal distortion due to amplitude error generated by magnitude variation in the load impedance, according to an example embodiment of the invention. As shown in FIG. 7, the amplitude of output signal is suppressed. In order to compensate for the amplitude error, the phase of the two inputs may have differential compensation values to shrink the angle between the two. Differential compensation values are values that have the same magnitude, but opposite signs/directions. This may generally be referred to as differential phase predistortion.

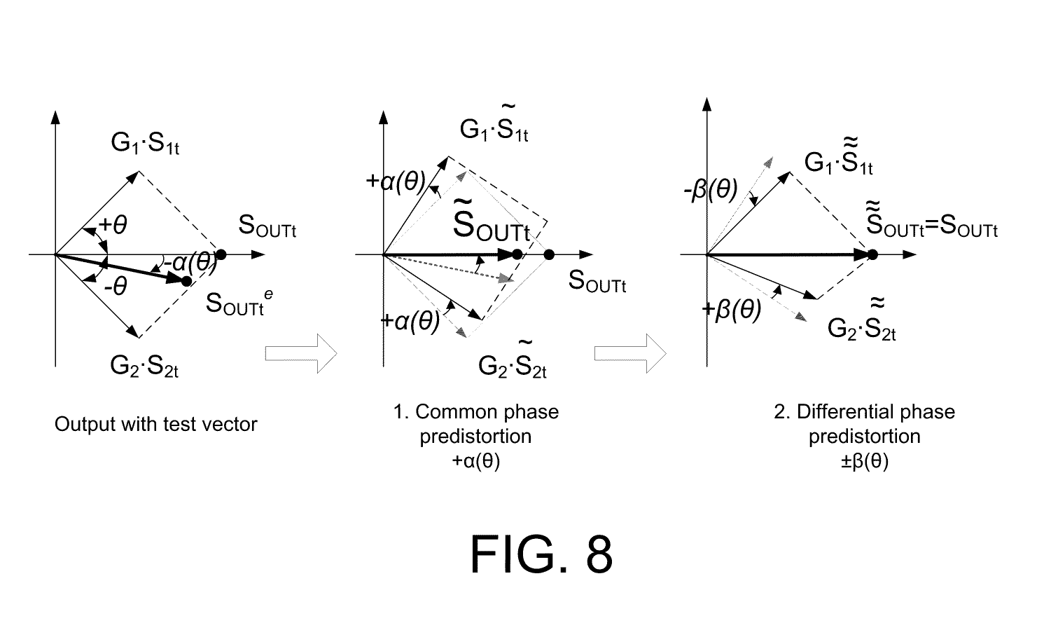

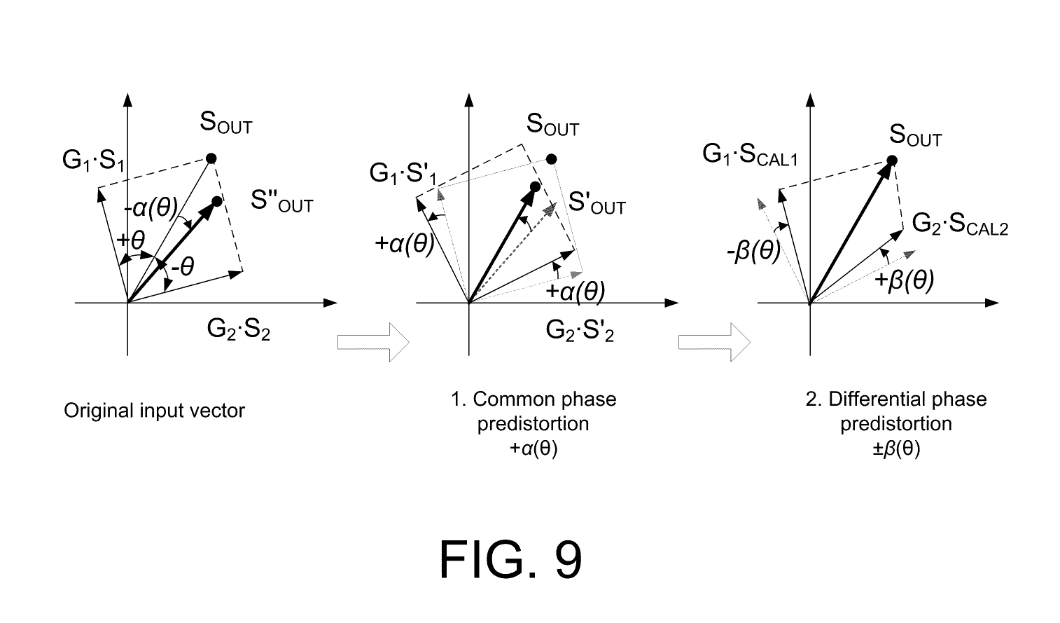

The combining errors can cause imperfect phase cancellation in the combiner, which generates phase and amplitude errors in the combiner output. FIG. 8 shows the example combiner response to the conjugate phase test signals, where S₁ₜ, S₂ₜ are the test signals for dynamic mismatch compensation, S_{OUTt} is the ideal output signal from the test signals, and S_{OUTt}^{e} is istorted output signal due to gain and phase errors at combiner. With reference to FIG. 8, suppose that at some out-phase angle, θ (e.g., 0<θ<90°, the output vector is no longer on the horizontal axis but rather its angle is negative. In this situation, both input signals should be calibrated in the same direction, +α(θ), to cancel the phase offset of the output. This may generally be referred to as common phase predistortion. Simultaneously, the amplitude of the combined output signal is also diminished due to the losses in passive components. This is also shown in FIG. 8. To remove the effects of losses, both input signals should be calibrated in the opposite direction, ±β(θ), to reduce the angle between the two vectors corresponding to the out-phase angle, ƒ. This may generally be referred to as differential phase predistortion. The original baseband symbol angle does not affect the compensation of mismatch, since the phase and amplitude distortion is only a function of the out-phase angle, θ (0<θ<90°). Therefore both compensation angles, α(θ) and β(θ), can be saved in digital look-up tables for each channel and calibrate the input bit streams of digital phase modulators as a function of the out-phase angle, θ, with simple digital addition or subtraction operations, as shown in FIG. 9. In FIG. 9, S″_{OUT} is the output signal with gain and phase errors at combiner, S′_{OUT} is the output signal after phase error calibration, and S_{OUT} is the output signal after gain and phase calibration, according to an example embodiment of the invention. The total number of test vectors for the digital calibration in n-bit digital phase modulator is 2ⁿ/4=2⁽ⁿ⁻²⁾, which is the number of possible phases in the first quadrant in FIG. 8.

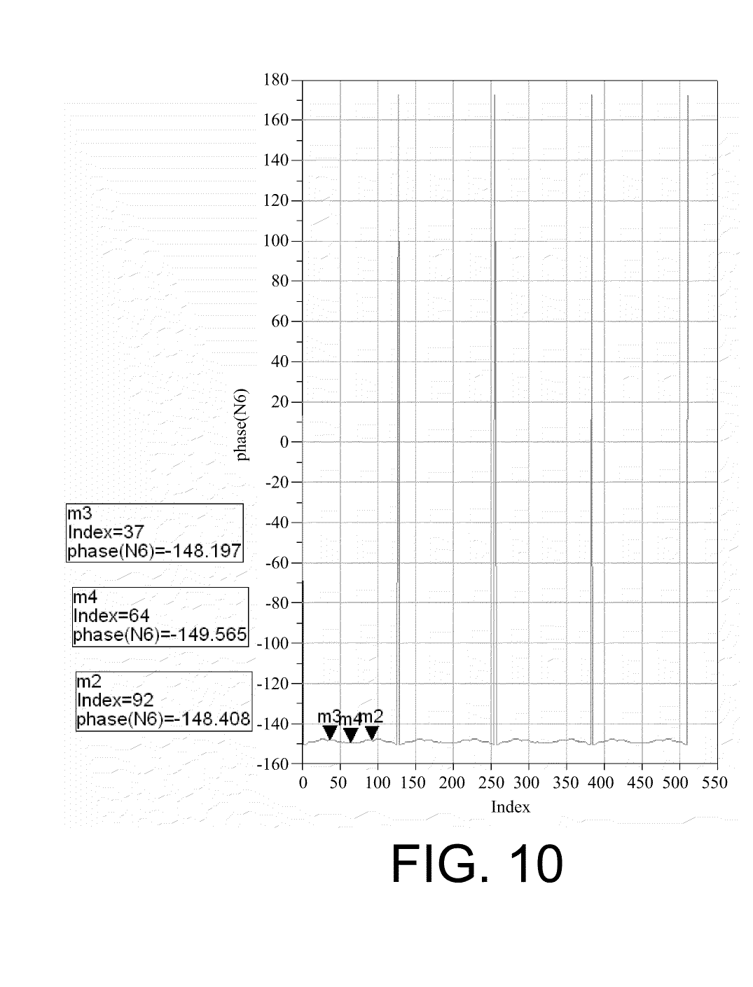

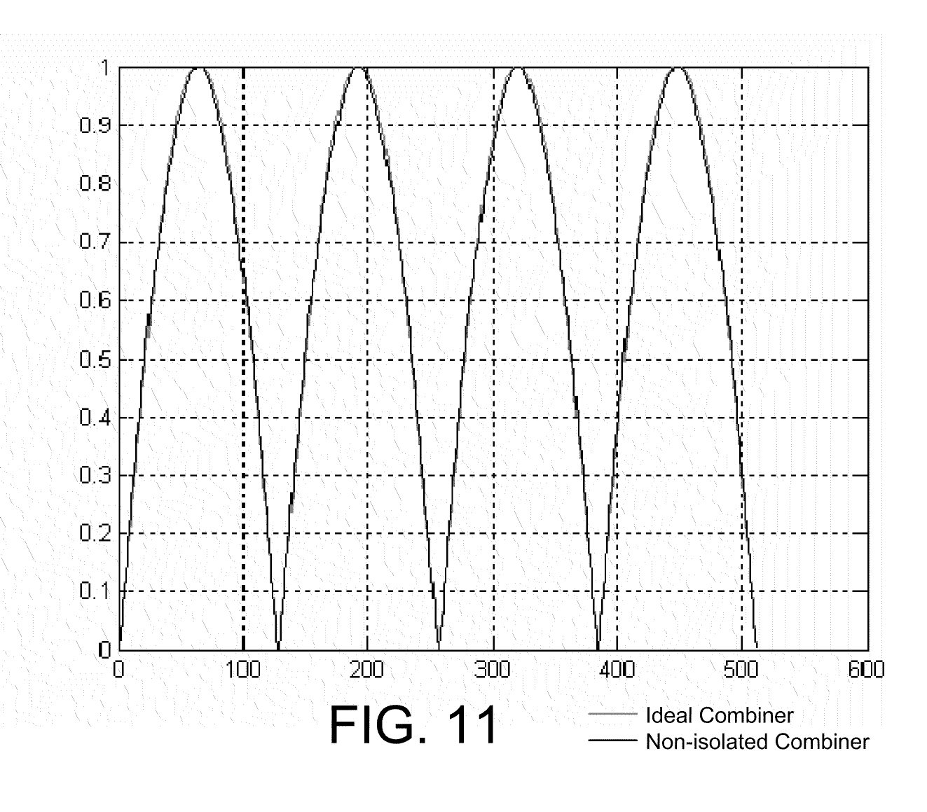

FIGS. 10 and 11 show the example simulation results after the phase and amplitude error compensations, respectively, according to an example embodiment of the invention. As shown in FIGS. 10 and 11, the output signal now has minimal distortion due to phase and amplitude errors.

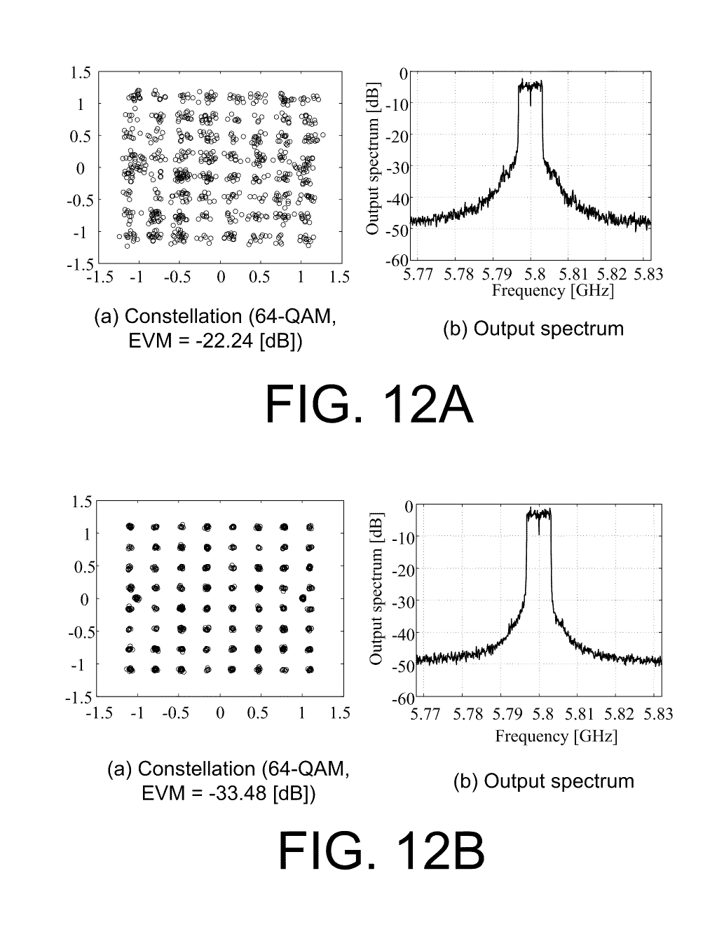

FIGS. 12A and 12B shows example simulation results demonstrating the performance of example calibration with real OFDM communication signals, according to an example embodiment of the invention. More specifically, FIG. 12A illustrates an example error vector magnitude (EVM) and spectrum of an example OFDM signal before applying the calibration algorithms, according to an example embodiment of the invention. In FIG. 12A, the EVM performance is −22.24 dB. FIG. 12B illustrates an example EVM and spectrum of an example OFDM signal after applying the calibration algorithms, according to an example embodiment of the invention. As shown in FIG. 12B, the EVM performance is improved up to −33.48 dB after applying the calibration algorithms.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A digital outphasing transmitter, comprising:
a signal component separator that receives a non-constant envelope input signal and at least one phase offset value, and generates first digital phase data and second digital phase data;
at least one digital phase modulator that receives the first phase data and the second phase data and operates with a frequency synthesizer to generate a first component signal having a first constant envelope and a second component signal having a second constant envelope;
at least one power amplifier that amplifies the first component signal and the second component signal to generate an amplified first component signal and an amplified second component signal;
a power combiner that combines the first amplified component signal and the second amplified component signal to generate an output signal having a non-constant envelope, wherein the power combiner is of a non-isolated type; and
a mismatch compensator that monitors the output signal to determine the at least one phase offset value, wherein the at least one phase offset value is utilized by the signal component separator for phase adjustment.

2. The digital outphasing transmitter of claim 1, wherein the at least one phase offset value is determined by the mismatch compensator in accordance with common phase predistortion, wherein the common phase predistortion results in a same phase compensation value being applied to the first component signal and the second component signals.

3. The digital outphasing transmitter of claim 2, wherein common phase predistortion is utilized to correct phase errors resulting from at least the non-isolated type power combiner.

4. The digital outphasing transmitter of claim 1, wherein the at least one phase offset value is determined by the mismatch compensator in accordance with differential phase predistortion, wherein the common phase predistortion results in differential phase compensation values being applied to the first component signal and the second component signals.

5. The digital outphasing transmitter of claim 4, wherein common phase predistortion is utilized to correct amplitude errors resulting from at least the non-isolated type power combiner.

6. The digital outphasing transmitter of claim 1, wherein the at least one digital phase modulator modulates the first phase data and the second phase data with I/Q clock signals from the frequency synthesizer to generate the first component signal and the second component signal.

7. The digital outphasing transmitter of claim 6, wherein the I/Q clock signals have a frequency that is at least four times faster than that of the output signal.

8. The digital outphasing transmitter of claim 1, wherein the mismatch compensator monitors the output signal to further determine at least one amplitude offset value, wherein the at least one amplitude offset value is utilized to adjust a gain of the at least one power amplifier.

9. The digital outphasing transmitter of claim 1, wherein the at least one digital phase modulator includes a first digital phase modulator and a second digital phase modulator, wherein the first digital phase modulator receives the first phase data and generates the first component signal, and wherein the second digital phase modulator receives the second phase data and generates the second component signal.

10. The digital outphasing transmitter of claim 1, further comprising at least one driver amplifier, wherein the at least one driver amplifier is configured to operate between the at least one digital phase modulator and the at least one power amplifier.

11. A method for a digital outphasing transmitter, comprising:
generating, by a signal component separator, first digital phase data and second digital phase data based upon a non-constant envelope input signal and at least one phase offset value;
receiving, by at least one digital phase modulator, the first phase data and the second phase data, wherein the at least one phase modulator operates with a frequency synthesizer to generate a first component signal having a first constant envelope and a second component signal having a second constant envelope;
amplifying, by at least one power amplifier, the first component signal and the second component signal to generate an amplified first component signal and an amplified second component signal;
combining, by a power combiner, the first amplified component signal and the second amplified component signal to generate an output signal having a non-constant envelope, wherein the power combiner is of a non-isolated type; and
monitoring, by a mismatch compensator, the output signal to determine the at least one phase offset value, wherein the at least one phase offset value is utilized by the signal component separator for phase adjustment.

12. The method of claim 11, wherein the at least one phase offset value is determined by the mismatch compensator in accordance with common phase predistortion, wherein the common phase predistortion results in a same phase compensation value being applied to the first component signal and the second component signals.

13. The method of claim 12, wherein common phase predistortion is utilized to correct phase errors resulting from at least the non-isolated type power combiner.

14. The method of claim 11, wherein the at least one phase offset value is determined by the mismatch compensator in accordance with differential phase predistortion, wherein the common phase predistortion results in differential phase compensation values being applied to the first component signal and the second component signals.

15. The method of claim 14, wherein common phase predistortion is utilized to correct amplitude errors resulting from at least the non-isolated type power combiner.

16. The method of claim 11, wherein the at least one digital phase modulator modulates the first phase data and the second phase data with I/Q clock signals from the frequency synthesizer to generate the first component signal and the second component signal.

17. The method of claim 16, wherein the I/Q clock signals have a frequency that is at least four times faster than that of the output signal.

18. The method of claim 11, wherein the mismatch compensator monitors the output signal to further determine at least one amplitude offset value, wherein the at least one amplitude offset value is utilized to adjust a gain of the at least one power amplifier.

19. The method of claim 11, wherein the at least one digital phase modulator includes a first digital phase modulator and a second digital phase modulator, wherein the first digital phase modulator receives the first phase data and generates the first component signal, and wherein the second digital phase modulator receives the second phase data and generates the second component signal.

20. The method of claim 11, further comprising:
amplifying, by at least one driver amplifier, the first component signal and the second component signal, wherein an output of the at least one driver amplifier is provided as an input to the at least one power amplifier that generates the amplified first component signal and the amplified second component signal.
